(19) United States
(12) Patent Application Publication
(10) Pub. No.: US 2006/0232047 A1
(43) Pub. Date: Oct. 19, 2006

(54) Protection against inadvertent air bag deployment

(76) Inventors: Robert Gallart, Brooklyn, NY (US); Park Benjamin III, Bayville, NY (US); Matthew Vishnick, Great Neck, NY (US); Jason Vishnick, Great Neck, NY (US); Robert S. Tucker, (US)

Correspondence Address: LAW OFFICE OF MORRIS E. COHEN, 1122 CONEY ISLAND AVENUE, SUITE 217, BROOKLYN, NY, 11230, US

(21) Appl. No.: 11/271,486

(22) Filed: Nov. 10, 2005

Related U.S. Application Data
(60) Provisional application No. 60/626,541, filed on Nov. 10, 2004.

(51) Int. Cl. B60R 21/16; B60K 28/00

(52) U.S. Cl. 280/728.1; 180/271

(57) ABSTRACT

An apparatus for affixation to the steering wheel of a vehicle in an accident. The apparatus blocks the air bag in the event of air bag deployment during a rescue operation, thereby shielding rescue workers and vehicle occupants from injury.

### RELATED APPLICATIONS

The present application claims the priority of U.S. Provisional Application Ser. No. 60/626,541 filed Nov. 10, 2005, which is fully incorporated herein by reference.

### FIELD OF THE INVENTION

The present invention relates to a safety device and method for preventing injury from undesired vehicular air bag deployment.

### BACKGROUND OF THE INVENTION

Air bags are safety devices commonly installed in modern vehicles, and are intended for use as a supplemental safety system in addition to vehicular seat belts. According to the National Highway Traffic Safety Administration, frontal air bags have saved 13,967 lives between 1987 and 2003. Since model year 1998, all passenger cars are required by law to have frontal air bags for the driver and the right front passenger seating positions. Likewise, since model year 1999, all light trucks (pickups, vans and SUVs) have been required to have such frontal air bags as well. In the case of a driver's side air bag, for example, the frontal air bag is located in the hub of the steering wheel.

Frontal air bags are generally designed to deploy in “moderate to severe” frontal or near-frontal impacts. Such crashes are equivalent to hitting a solid, fixed barrier at least eight to fourteen mph, or to striing a parked car of similar size at least sixteen to twenty eight mph. During such crashes, a signal is sent from the Electronic Control Unit (ECU) to the inflator within the air bag module. An igniter in the inflator subsequently initiates a chemical reaction which releases a harmless gas (typically nitrogen or argon) which rapidly inflates the air bag, typically in thirty to fifty milliseconds. The inflation of the air bag creates a rapidly pressurized cushion intended to prevent the occupants' upper body or head from hitting the interior of the vehicle.

Air bag inflation is extremely rapid and of high force—it has been estimated for example, that the typical air bag deploys at approximately two hundred to three hundred miles per hour producing a force against the occupant equivalent to approximately a two thousand pound impact force at thirty miles per hour. The force is sufficient that air bag inflation itself has been known to cause injury. After inflation, the air bag will then automatically deflate as the gas exits through vents located in the air bag's fabric.

Following a vehicle collision, emergency personnel responding to the accident will remove any trapped occupants from the vehicles, and forward them on to any medical treatment that may be necessary. Unfortunately, however, there are currently significant potential dangers to emergency personnel and vehicle occupants resulting from undesired air bag deployment during the rescue procedure (also referred to herein as latent air bag deployment). While removing an occupant from a vehicle, an air bag can spontaneously deploy, potentially causing injury to the rescue worker attempting to provide emergency assistance, and/or to the occupant still located within the vehicle. This accidental air bag deployment can result from numerous causes, including, but not limited to, system malfunctions, inadvertent damage to the vehicle air bag control module, failure to properly deactivate the vehicle electrical system, or so forth. Due to the fact that air bags deploy so rapidly and so forcefully, serious or even fatal injuries can occur if the rescue worker (or the occupant) is too close to, or is in direct contact with, the air bag when it deploys. Likewise, such undesirable deployment can impact the rescue worker causing him or her to strike the occupant, causing injury or death to both parties.

Accordingly, the present invention provides a safety mechanism which prevents injury to these very personnel attempting to provide rescue assistance and to the occupants themselves.

### SUMMARY OF THE INVENTION

In accordance with the present invention, an apparatus is disclosed for use inside a vehicle to prevent injury from unintentional air bag deployment, particularly after a vehicle accident. Preferably, the apparatus consists of a reusable barrier designed and configured for rapid mounting onto the vehicle's steering wheel. The barrier is provided and configured to absorb the impact of the air bag upon rapid release from its storage compartment and/or to deflect the same.

Further to the method of the invention, rescue workers may rapidly affix the apparatus to the steering wheel upon arrival at an accident scene, to provide a mechanism for blocking and/or deflecting the air bag in the event of undesirable air bag deployment during the rescue, thereby preventing the air bag from hitting or otherwise affecting the rescue workers or the occupants of the vehicle. Should the air bag inadvertently deploy, the apparatus of the invention acts as a protective shield preventing the high force of air bag ejection from directly or indirectly causing bodily injury or death.

Preferably, the apparatus is designed for quick mounting upon and removal from the steering wheel. Further preferably, the apparatus is designed for reusability of the same device by rescue workers from accident to accident. Yet further preferably, the apparatus prevents full inflation and subsequent re-inflation or secondary inflation of an air bag and/or provides for deflection of the same.

As a result, an apparatus is provided which prevents injury from undesired air bag deployment, whether to rescue workers or vehicle occupants. Further objects and advantages of the invention will become apparent in conjunction with the detailed disclosure provided herein.

### BRIEF DESCRIPTION OF THE DRAWINGS

FIG. 1 is a front view of a first configuration of a preferred embodiment of an apparatus in accordance with the present invention.

FIG. 2 is a further front view of the embodiment of FIG. 1, in a second configuration after rotation of the crossbars.

FIG. 3(a) is a side perspective of the configuration illustrated in FIG. 2.

FIG. 3(b) is a further side view of the preferred embodiment of FIG. 1 after rotation of the crossbars.

FIG. 4 is a back view of the configuration illustrated in FIG. 2.

FIG. 5 is a front view of the apparatus of FIG. 1, after affixation to a steering wheel, in accordance with the method of the present invention.

FIG. 6 is a side perspective view of the configuration shown in FIG. 5.

### DETAILED DESCRIPTION OF THE DRAWINGS AND THE PREFERRED EMBODIMENTS

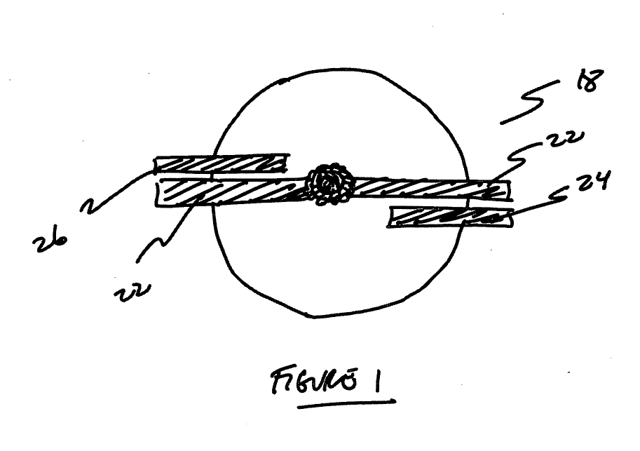

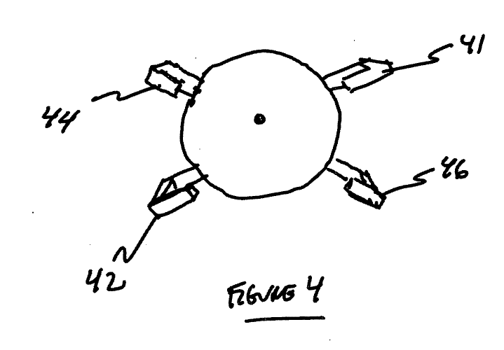

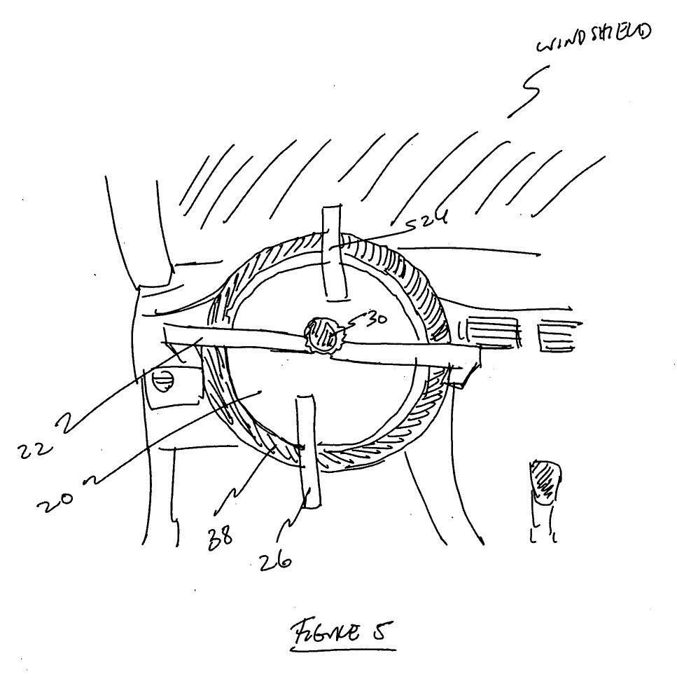

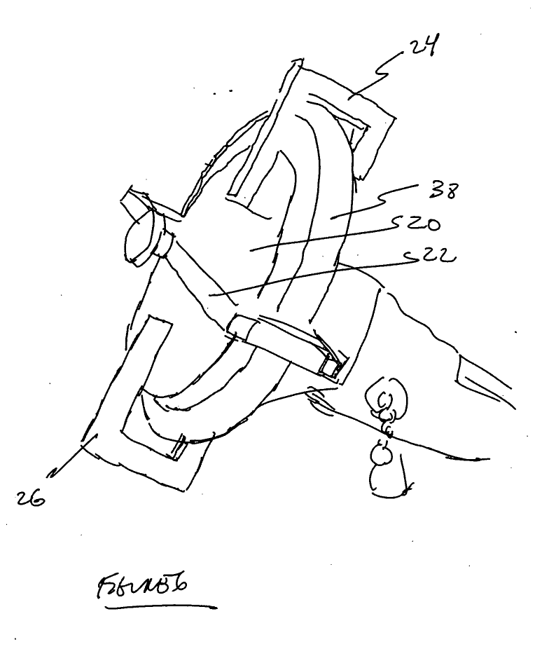

In accordance with the apparatus and method of the present invention, and as shown in FIGS. 1 through 6, a safety device 18 for protecting against air bag deployment is provided for affixation to the steering wheel of a vehicle having experienced an auto accident. The safety device is constructed such that it can be tightened against a steering wheel, and, when so tightened, will withstand the impact of air bag ejection from the steering wheel without coming off of the wheel.

As shown in FIG. 1, safety device 18 preferably includes a shield or plate 20. Shield or plate 20 is a rigid piece of material which is used to block an air bag and is designed to withstand the characteristic pressures and speeds of typical air bag inflation and ejection. Preferably, the shield is flat on bottom; however, it can be of any shape and configuration suitable to cover the top of a steering wheel, whether a disk shape, a shallow bowl shape, or so forth.

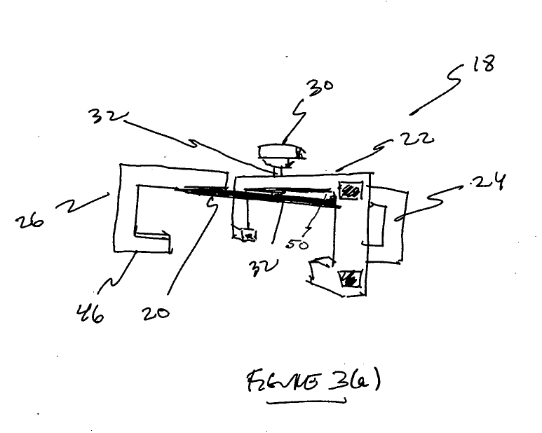

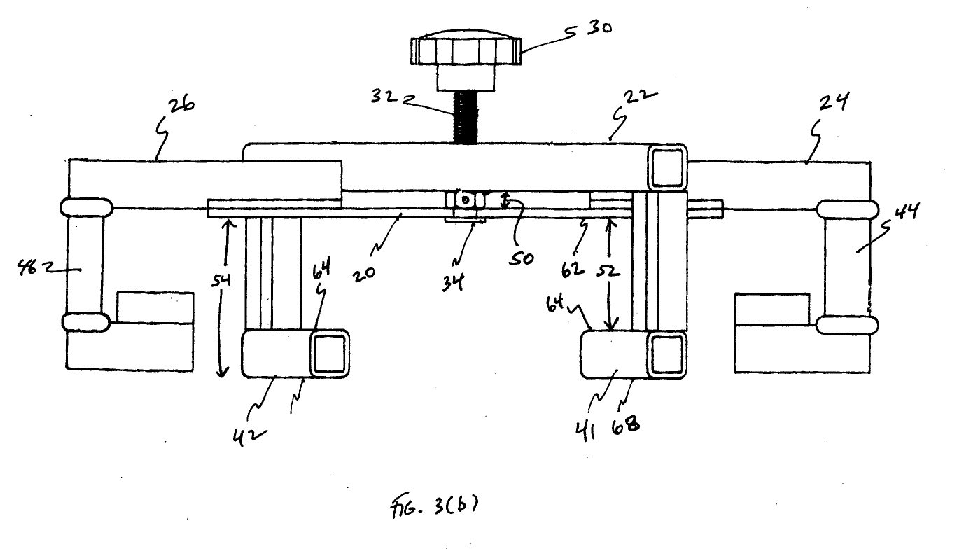

Preferably, safety device 18 further includes one or more bars, as well, such as first bar or crossbar 22, a second bar or crossbar 24, and a third bar or crossbar 26. As shown in FIG. 3, in the preferred embodiment first crossbar 22 consists of a single long arm extending across shield 20 (preferably across the entire diameter of the shield). Second and third crossbars 24 and 26 each consist of a short arm, with such short arm being affixed to the shield 20, preferably at or near the shield's circumference. The two short arms or bars 24 and 26 are preferably parallel to each other, as shown in FIG. 1.

The long arm is preferably connected to the shield using a threaded rod, as discussed below. The short arms can be affixed by gas or electric welding or their combination (e.g. using a MIG welding machine), or via any other suitably secure method. In an alternative embodiment, two long arms can be provided, each of those arms extending across the shield's diameter.

The crossbars, whether short or long, can be attached to and along the top or bottom of the shield 20, or to the side of shield 20 (although attachment to the top is preferred). Alternatively, the shield and one or more of the crossbars can be a single integral unit, with those crossbars extending out of the shield (e.g. out of the side or top).

In the preferred embodiment, the long atm of crossbar 22 extends over the shield or plate as illustrated in the figures, with this long arm being connected to the shield using a threaded rod, as discussed below. In this embodiment, the short arms extend from or are directly affixed to the shield.

Further preferably, one or more of the bars (or all of the bars), is rotatable in an arc about an axis perpendicular to the top surface of the shield. In a further preferred embodiment, this axis extends through the center of the top of the shield, and is colinear with the threaded rod which preferably extends through that center. In the embodiment of the single long arm and two short arms shown in FIG. 1, the long arm will rotate in an arc until it hits the two short arms (or vice versa, the two short arms will each rotate in an arc until they each hit the long arm). FIG. 1 shows the arms so rotated, to achieve a compact or “folded up” position.

Alternately, any other combination of shield size and configuration and/or any other number or configuration of shield, crossbars, grips and clamps can be provided, so long as consistent with the objectives described herein.

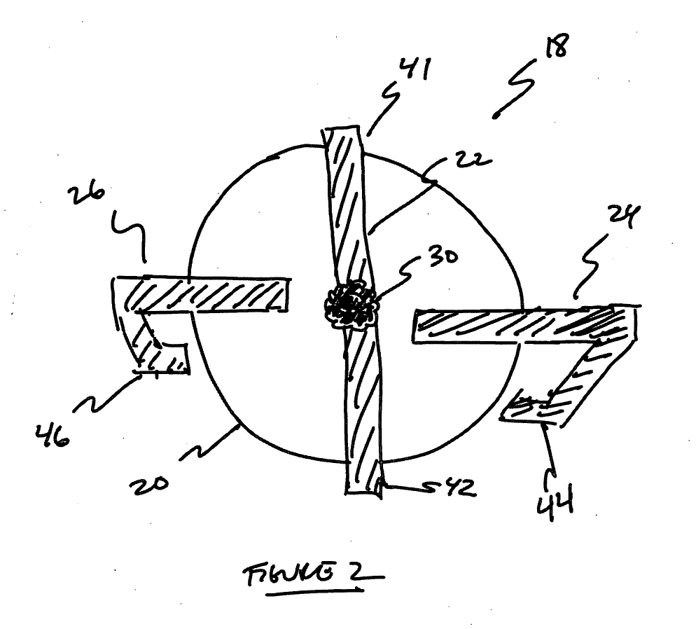

At the end of each bar 22, 24 and 26, a grip or clamp is provided as shown in FIG. 2. These grip are used to secure the bar to the steering wheel and/or extend the bar under the steering wheel. With respect to first crossbar 22 of the figures, two grips 41 and 42 are provided, one at each end. With respect to second crossbar 24, a single grip 44 is provided on the end of the crossbar extending away from the shield 20, and similarly a single grip 46 is also likewise provided at the end of third crossbar 26. Second and third crossbars 24 and 26 thus preferably have a single grip at one end and are affixed at the other end to shield 20. For example, the second and third crossbars can be welded to the shield's surface, or the shield with the second and third crossbars can be molded as an integral unit.

Grips 41, 42, 44 and 46 can be in any desired shape suitable for gripping the steering wheel, and are of a suitable size to contact the bottom of the steering wheel when the safety device is placed on and tightened against the wheel. Preferably, the grips are secured to the rim and/or the back of the wheel. Thus, they can be an L-shaped extension as shown in the figures; in other words, the piece at the end of the bar can be an “L” shaped segment or the entire bar with grip can be an “L” shape. Likewise, the piece at the end of the bar can be more rounded “C” shaped segment or the entire bar with grip can be a “C” shape. Or, if desired another suitable shape can be used. The grips themselves can be entirely metal, or they can include a rubber or foam layer or pad for additional friction.

In accordance with the operation the invention, the safety device 18 can be tightened against the steering wheel by a rescue worker or other personnel. For example, as shown in FIG. 3, safety device 18 includes a knob 30 attached to the top end of a threaded rod 32, with threaded rod 32 extending through and beyond a hole in first crossbar 22. At the bottom of threaded rod 32, the rod is affixed to the center of shield 20 of the safety device. The rod can be affixed to the shield to avoid separation therefrom using any suitable method known in the art, whether with a cotter pin or disk 34 attached to the rod below the shield, or by making the diameter of the rod segment below the shield larger than the diameter of the hole, or so forth. The rod, knob and shield are therefore configured such that rotation of the threaded rod (by rotation of knob 30) either moves shield 20 farther away from or closer to the top of first crossbar 22, depending on the direction of rotation of the threaded rod and/or knob. In other words, rotation of the threaded rod using knob 30 increases or decreases the space 50 between shield 20 and crossbar 22.

Or, put in another way, rotation of the threaded rod increases or decreases the distance or space 52 between the bottom 62 of the shield and the top surface 64 of the bottom segment of each of the grips of the first bar (the top surfaces being those which contact the steering wheel's lower surface in the illustrated preferred embodiment). Likewise, rotation of the threaded rod also increases or decreases the distance or space 54 between the bottom 62 of the shield and the bottom surface 68 of the grips of the first bar.

In this manner, the entire device becomes an adjustable clamp which can be easily tightened against and secured to the steering wheel, and easily loosened and removed from that wheel. The rescue worker can variably tighten and or loosen the device to the degree required, with rotation of the knob causing the size of the spaces 50, 52, and 54 to increase or decrease. For convenience, space 50 is referred to as a vertical space, in reference to its orientation along a vertical axis (perpendicular to the ground), when the device is resting on a table (with the shield parallel to the tabletop or ground). However, it will of course be understood that in use, the shield is not parallel to the ground, but rather is parallel to the top surface of the steering wheel. Thus, in that configuration, the space is along a line perpendicular to the steering wheel's top surface. In that configuration, the term “vertical space” uses the top of the steering wheel as a reference or ground level; the same space between the bar and shield is intended.

In the closed position for storage, second and third crossbars 24 and 26 are preferably folded down near or against first crossbar 22, such that the second and third crossbars are approximately parallel to first crossbar 22, as shown in FIG. 1. Due to the design of the safety device, which uses a threaded rod as discussed above, first crossbar 22 can be easily rotated. Rotation allows movement of crossbars 22, 24 and 26 from the closed position to the open position (and back again). In the open position, second and third crossbars 24 and 26 are each configured perpendicular or approximately perpendicular to first crossbar 22, as shown in FIGS. 2 through 6. When not in use, safety device 18 is maintained in the closed position to allow convenient storage, such as when the device is being kept in or transported on a fire truck or other rescue vehicle.

In accordance with the method of the invention, when arriving at the scene of an accident, safety device 18 is carried to the vehicle which will become the subject of rescue efforts. After obtaining access to the vehicle's interior, the safety device 18 can be placed onto the steering wheel.

Preferably, for ease of insertion, the rescue worker begins by holding safety device 18 in the closed position as discussed above. The rescue worker initially slips safety device 18 over and onto steering wheel 38, with the safety device 18 in the closed position such that the grips at one end of first crossbar 22 and at the end of crossbar 24 are on one side of steering wheel, and the grip at the other end of first crossbar 22 and at the end of crossbar 26 are on the other side. Safety device 18 is then moved into the open position, by rotation of crossbars 24 and 26 to a position approximately perpendicular to first crossbar 22 as described above.

Once the safety device has been moved to the open position, knob 30 is rotated to increase the space 50 between first crossbar 22 and shield 20. Increase of this space pulls the grips forward so as to move them toward and against the back of steering wheel 38, tightening shield 20 against the face of steering wheel 38, and tightening the entire safety device against the steering wheel. In this manner, continued rotation of knob 30 quickly tightens the shield 20 against the front of the steering wheel and the grips against the steering wheel's back, resulting in a firm and secure attachment and tightening of safety device 18 to steering wheel 38.

In this attached position, shield 20 acts as a secure barrier against steering wheel 38. In the event of accidental deployment of the air bag during rescue, the air bag will impact the rear of shield 20, with the durable construction of safety device 18 and tight attachment of shield 20 to steering wheel 38 preventing the air bag from hitting or otherwise affecting the rescue worker or vehicle occupant.

Accordingly, consistent with the invention, shield 20 and the remaining components of safety device 18 are constructed of materials of sufficient strength and thickness such that they can withstand the impact of air bag deployment while the safety device 18 is affixed to the steering wheel, and such that the force of deployment is absorbed and/or deflected by the safety device, with the device remaining affixed to the steering wheel 38. For example, safety device 18 can be constructed of cold rolled steel, or another suitable material. Preferably, the interior of crossbars 22, 24 and 26 are hollowed out to decrease the weight of the device without affecting its durability and strength. Depending on the size, configuration and dimensioning of the components of the invention (e.g. the shield and so forth), the air bag can be fully contained within the device, or may extend out of the sides slightly upon deployment. In the event that the air bag extends slightly out of the sides, the force of impact is nonetheless sufficiently absorbed, diminished and/or deflected by the shield to prevent harm to nearby individuals.

Further preferably, the components of safety device 18 are dimensioned such that they can be affixed over any of the various steering wheels of different sizes provided in the art. For example, by providing the crossbars and their grips of sufficient size, the device can be fitted over any commercially available steering wheel available in the art. Since the grips “double back” toward themselves, and are tightened in use, they can be used to secure the safety device 18 against a variety of steering wheels of different sizes. In this manner, a single “universal” device can be carried by rescue workers for use with a variety of different automobiles, without the need for separate devices or separate sizes for different automobile makes or models. The dimensions of the device can be varied, of course, depending on the vehicular dimensions then current in the art. U.S. Provisional Application Ser. No. 60/626,541 filed Nov. 10, 2005 (which is fully incorporated herein by reference), illustrates some useful dimensions, although the present invention is not limited to those shown therein.

In addition, a further advantage of the invention is that the design provided allows reuse of safety device 18 as often as desired. Once rescue operations are completed, the safety device is removable. Knob 30 can be rotated in the opposite direction to loosen safety device 18 from the steering wheel, followed by rotation of the crossbars to the closed position and removal of the safety device from the steering wheel and vehicle. The safety device can then be used to assist in the next accident and any subsequent ones, without the need to obtain a new safety device after air bag deployment.

In a further alternative embodiment of the invention, no shield is utilized. Rather, only a single crossbar is provided, with the crossbar resting and extending across the face of the steering wheel. The crossbar is clamped to the steering wheel by rotating a knob affixed to a threaded rod, as with the preferred embodiment previously described. In this alternative embodiment, a threaded rod with a cutting tip can also be provided. This threaded rod extends out of the grip and is rotated using the knob at its end to cut into the steering wheel (or the steering column) so as to provide added stability when securing the single crossbar. (This non-preferred embodiment is illustrated in FIG. 8 of U.S. Provisional Application Ser. No. 60/626,541 filed Nov. 10, 2005, which application is fully incorporated herein by reference. Some dimensions of this embodiment are shown on that figure.)

As yet a further additional feature of any of the embodiments of the invention, knob 30 may also have a cutting tip added to the end of threaded rod 32 (as shown for example in FIG. 8 of U.S. Provisional Application Serial No. 60/626,541), although this embodiment is not preferred. When knob 30 is rotated, the cutting tip cuts into the front of the steering wheel (the steering wheel's face). This knob both assists in securing the apparatus onto the steering wheel, and also creates one or more holes in the airbag, since the airbag is folded into a compartment in the steering wheel. These holes prevent the airbag from fully inflating and/or reduce the velocity of air bag deployment.

However, in the preferred embodiments of the invention, no cutting tips or other such objects or sharp surfaces are provided to the safety device particularly not on the bottom of the shield). The shield, for example, is preferably flat and smooth on the bottom. Sharp edges and protruding spikes are avoided on the shield and anywhere else on the device to minimize unnecessary damage to the steering wheel and avoid any potential laceration of rescue personnel.

As a further additional or alternative feature of any of the embodiments of the invention described above, individual clamps can be provided at one or more of the grips at the end of the crossbars. Using this feature, one or more of the individual clamps are tightened against the steering wheel to secure the device. These individual clamps can be provided in addition to, or instead of, the knob at the top of the shield, although the use of the single knob is preferred.

In yet a further embodiment of the invention, a durable bag is placed over the device once it has been affixed to the steering wheel, as an additional shield for further safety and protection. Preferably, the bag is made of a highly tear resistance and durable material, such as ripstop nylon, Kevlar® brand material (Kevlar® being a commercial trademark for a type of aramid fiber), or so forth. The bag is used to provide additional protection to the rescue worker and vehicle occupant from any flying debris or parts that may be ejected during airbag deployment. Preferably, this bag includes a strap used to affix the air bag to the steering wheel, whether a nylon strap that ties around the steering wheel, or an elastic strap that secures around the steering wheel, or so forth. If desired, the bag can include a handle as well, for convenience.

Having described this invention with regard to specific embodiments, it is to be understood that the description is not meant as a limitation since further embodiments, modifications and variations may be apparent or may suggest themselves to those skilled in the art. It is intended that the present application cover all such embodiments, modifications and variations.

What is claimed is:

1. An article of manufacture, comprising:
(a) a safety device for placement on a vehicle's steering wheel, said safety device comprising a shield and a bar, said bar extending across said shield;
(b) said safety device comprising a vertical space between said bar and said shield;
(c) wherein the size of said vertical space said safety device is adjustable by a user when said safety device is placed on the steering wheel, so as to allow the user to tighten said safety device against the steering wheel.

2. An article of manufacture as claimed in claim 1, wherein said shield and said bar are connected by a threaded rod, said threaded rod being rotatable by a user to adjust said size of said vertical space.

3. An article of manufacture as claimed in claim 1, wherein said safety device comprises a knob, said size of said vertical space being adjustable by rotation of said knob.

4. An article of manufacture as claimed in claim 1, wherein said bar further comprises a grip used to secure said safety device to the steering wheel, said grip being of suitable size and shape to contact the bottom of the steering wheel when said safety device is placed on and is tightened against the steering wheel.

5. An article of manufacture as claimed in claim 1, wherein said safety device will withstand the impact of air bag ejection from the steering wheel without coming off of the steering wheel, when said safety device is tightened against the steering wheel.

6. An article of manufacture as claimed in claim 1, wherein said bar extends under the steering wheel when said safety device is tightened against the steering wheel.

7. An article of manufacture as claimed in claim 2, wherein said safety device further comprises a second bar, wherein and said shield comprises a top surface and comprises an axis perpendicular to said top surface, and wherein said second bar is rotatable in an arc about said axis.

8. An article of manufacture as claimed in claim 1, wherein said safety device is free of protruding spikes.

9. An article of manufacture, comprising:
(a) a safety device for placement on a vehicle's steering wheel;
(b) said safety device comprising a shield and at least two bars, a first bar and a second bar;
(c) said shield comprising a top surface, and comprising an axis perpendicular to said top surface;
(d) and wherein said second bar is rotatable in an arc about said axis.

10. An article of manufacture as claimed in claim 9, wherein said safety device further comprises a third bar, said third bar being parallel to said second bar.

11. An article of manufacture as claimed in claim 10, wherein said second bar and said third bar can be rotated to an orientation wherein said second bar and said third bar are each perpendicular to said first bar.

12. An article of manufacture as claimed in claim 9, wherein said first bar comprises two grips and said second bar comprises at least one grip, said grips being used to secure said safety device to the steering wheel and being of suitable size and shape to contact the bottom of the steering wheel when said safety device is placed on and is tightened against the steering wheel.

13. An article of manufacture as claimed in claim 9, wherein said safety device will withstand the impact of air bag ejection from the steering wheel without coming off of the steering wheel, when said safety device is tightened against the steering wheel.

14. An article of manufacture as claimed in claim 9, wherein said safety device is free of protruding spikes.

15. An article of manufacture as claimed in claim 9, wherein said safety device comprises a vertical space between said bar and said shield, and said shield and said bar are connected by a threaded rod, said threaded rod being rotatable by a user to adjust said size of said vertical space when said safety device is placed on the steering wheel, so as to allow the user to tighten said safety device against the steering wheel.

16. An article of manufacture as claimed in claim 15, wherein said threaded rod extends through said first bar, and wherein a knob is provided on said threaded rod, said size of said vertical space being adjustable by rotation of said knob.

17. An article of manufacture, comprising:
(a) a safety device for placement on a vehicle's steering wheel, said safety device comprising a shield and a first bar, said first bar extending across said shield;
(b) said safety device comprising a vertical space between said first bar and said shield;
(c) wherein the size of said vertical space is adjustable by a user when said safety device is placed on the steering wheel, so as to allow the user to tighten said safety device against the steering wheel.
(d) said safety device further comprising a second bar and a third bar;
(e) said shield comprising a top surface, and comprising an axis perpendicular to said top surface;
(f) said second bar and said third bar being rotatable in an arc about said axis;
(g) and wherein said safety device will withstand the impact of air bag ejection from the steering wheel without coming off of the steering wheel, when said safety device is tightened against the steering wheel.

18. An article of manufacture as claimed in claim 17, wherein said third bar is parallel to said second bar.

19. An article of manufacture as claimed in claim 17, wherein said second bar and said third bar can be rotated to an orientation wherein said second bar and said third bar are both perpendicular to said first bar.

20. An article of manufacture as claimed in claim 17, wherein said shield and said bar are connected by a threaded rod, said threaded rod being rotatable by a user to adjust said size of said vertical space.
